(19) United States
(12) Patent Application Publication
(10) Pub. No.: US 2013/0182621 A1
(43) Pub. Date: Jul. 18, 2013

(54) INFORMATION COLLECTION SYSTEM, TERMINAL AND SINK NODE USING WIRELESS MULTIHOP NETWORK, AND COMMUNICATION METHOD FOR THE SAME

(71) Applicant: Tomohiko Yagyu, Tokyo (JP)

(72) Inventor: Tomohiko Yagyu, Tokyo (JP)

(73) Assignee: NEC CORPORATION, Minato-ku, Tokyo (JP)

(21) Appl. No.: 13/823,175

(22) PCT Filed: Sep. 15, 2011
(86) PCT No.: PCT/JP2011/071118

§ 371 Date: Mar. 14, 2013

(30) Foreign Application Priority Data
Nov. 30, 2010 (JP) 2010-266935

(51) Int. Cl. H04W 74/08

(52) U.S. Cl. CPC H04W 74/0816
USPC 370/310

(57) ABSTRACT

In a wireless multihop network, collision between a routing control message and an information collection message is avoided, and information collection is completed within a predetermined time. A terminal includes: a transmission period control unit that calculates transmittable periods of a routing control message and an information collection message per hop, based on a hop count from the sink node and the number of terminals per hop, calculate a collision period during which the routing control message collides with the information collection message, based on both of the calculated transmittable periods, and recalculates the transmittable period of the routing control message so as to transmit the routing control message while avoiding the calculated collision period; a routing control unit that creates and transmits the routing control message within the transmittable period of the routing control message according to a hop count of the terminal; and an information transmission unit that creates and transmits the information collection message within the transmittable period of the information collection message according to a hop count of the terminal.

### TECHNICAL FIELD

The present invention relates to an information collection system, a terminal and a sink node using a wireless multihop network, and a communication method for the same, and in particular, to an information collection system, a terminal and a sink node using a wireless multihop network, which performs transmission control according to a transmission schedule of a message for periodic information collection by the wireless multihop network, and a communication method for the same.

### BACKGROUND ART

Automatic metering by smart meters or information collection systems (sensor networks) using sensors have recently attracted attention.

In these systems, information collection via wireless manner is often used because of ease of installation and low cost. In particular, a wireless multihop network is used to enable communication by causing another terminal to perform relay with respect to a terminal that exists in a range which cannot be performed direct wireless communication by an information collection node (hereinafter, referred to as “sink (or sink node)”) of an information collection server or the like.

The wireless multihop network requires a routing control that determines to which terminal a packet is addressed and to whom the packet is relayed. Regarding the routing control techniques of the wireless multihop network, there are technologies disclosed in Non Patent Literatures 1 to 3. By using these techniques, an arbitrary terminal can communicate with another arbitrary terminal.

Also, regarding the transmission scheduling methods for avoiding radio interference at the time of information collection, techniques disclosed in Non Patent Literatures 4 and 5 are known.

By combining these technologies, an information collection system can be constructed in a wireless multihop network.

### CITATION LIST

### Non Patent Literature

{NPL 1} K. Mase, S. Kameyama, “Multihop hello guided routing-reactive for mobile ad hoc networks”, IEEE ISCAS 2005, vol. 3, page 2958-2961

{NPL 2} T. Clausen et al., “Optimized Link State Routing Protocol (OLSR)”, Internet Engineering Task Force (IETF) Request For Comments (RFC) 3626, October 2003

{NPL 3} C. Perkins, E. Belding-Royer, and S. Das., “Ad hoc On-Demand Distance Vector (AODV) Routing.”, IETF RFC3561. July 2003

{NPL 4} MATSUDA Takashi et al., “Data Transmission Scheduling Based On RTS/CTS Exchange for Periodic Information Collection Type Sensor Network”, Technical Report of The Institute of Electronics, Information and Communication Engineers (IEICE), NS2006-7, 2006

{NPL 5} KUBO Yuki et al., “Self-Organizing Communication Timing Control: Evaluation of Robustness to Communication Error”, Society Conference of The Institute of Electronics, Information and Communication Engineers (IEICE), 2005

### SUMMARY OF INVENTION

### Technical Problem

In a wireless multihop network, a routing control for establishing a communication path from each terminal to a sink is performed in such a manner that a routing control message transmitted from the sink is transmitted to terminals, which are sequentially away from the sink. On the contrary, information collection is performed in such a manner that an information collection message is transmitted while aggregating information in a direction from a terminal, which is farthest from the sink, to the sink.

That is, the routing control message and the information collection message are transmitted in an opposite direction. Therefore, in a case where there is no margin for communication bands with respect to the number of terminals, even though scheduling for collision avoidance is performed as in Non Patent Literatures 4 and 5, transmission timing of the routing control message and transmission timing of the information collection message inevitably collide with each other. In a case where the transmission collision between the routing control message and the information collection message occurs, a message transmission delay occurs. Consequently, it is likely that a required time of periodic information collection cannot be satisfied.

The present invention has been made to solve the above problem and is directed to provide an information collection system using a wireless multihop network, which can complete information collection within a predetermined time by avoiding collision between a routing control message and an information collection message in the wireless multihop network, a terminal, a sink node, and a communication method for the same.

### Solution to Problem

According to a first aspect of the present invention, there is provided a terminal of a system that performs periodic information collection in a wireless multihop network,

the terminal including:

a transmission period control unit that, based on a hop count from a sink node constituting the wireless multihop network and the number of terminals at each hop, calculates a transmittable period of a routing control message per hop so as to establish a path toward the sink node and a transmittable period of an information collection message per hop so as to transmit collected information toward the sink node, calculate a collision period during which the routing control message collides with the information collection message, based on both of the calculated transmittable periods, and recalculates the transmittable period of the routing control message so as to transmit the routing control message while avoiding the calculated collision period;

a routing control unit that creates and transmits the routing control message within the transmittable period of the routing control message according to a hop count of the terminal itself; and

an information transmission unit that creates and transmits the information collection message within the transmittable period of the information collection message according to a hop count of the terminal itself.

According to a second aspect of the present invention, there is provided a sink node of a system that performs periodic information collection in a wireless multihop network,

the sink node including:

an information collection unit that receives an information collection message for transmitting collected information, which is to be transmitted from a terminal constituting the wireless multihop network toward the sink node; and

a routing control unit that acquires, from the information collection message, the number of terminals per hop from the sink node, and transmits the acquired number of terminals per hop while inserting the acquired number of terminals per hop into a routing control message for establishing a path toward the sink node.

According to a third aspect of the present invention, there is provided a sink node of a system that performs periodic information collection in a wireless multihop network,

the sink node including:

an information collection unit that receives an information collection message for transmitting collected information, which is to be transmitted from a terminal constituting the wireless multihop network toward the sink node;

a transmission period control unit that acquires, from the information collection message, the number of terminals per hop from the sink node, calculates a transmittable period of a routing control message per hop so as to establish a path from the terminal toward the sink node and a transmittable period of an information collection message per hop so as to transmit collected information toward the sink node, based on the acquired number of terminals per hop, calculate a collision period during which the routing control message collides with the information collection message, based on both of the calculated transmittable periods, and recalculates the transmittable period of the routing control message so as to transmit the routing control message while avoiding the calculated collision period; and

a routing control unit that transmits the calculated transmittable periods of the information collection message and routing control message per hop while inserting the calculated transmittable periods into a routing control message of the sink node itself.

According to a fourth aspect of the present invention, there is provided a system that performs periodic information collection in a wireless multihop network, the system comprising a sink node and a terminal which constitute the wireless multihop network,

the sink node including:

an information collection unit that retains an information collection message for transmitting collected information, which is to be transmitted from the terminal toward the sink node; and

a routing control unit that acquires, from the information collection message, the number of terminals per hop from the sink node, and transmits the acquired number of terminals per hop while inserting the acquired number of terminals per hop into a routing control message for establishing a path toward the sink node,

the terminal including:

a transmission period control unit that calculates transmittable periods of a routing control message per hop and an information collection message per hop, based on a hop count from the sink node and the number of terminals per hop, calculate a collision period during which the routing control message collides with the information collection message, based on both of the calculated transmittable periods, and recalculates the transmittable period of the routing control message so as to transmit the routing control message while avoiding the calculated collision period;

a routing control unit that creates and transmits the routing control message within the transmittable period of the routing control message according to a hop count of the terminal itself; and

an information transmission unit that creates and transmits the information collection message within the transmittable period of the information collection message according to a hop count of the terminal itself.

According to a fifth aspect of the present invention, there is provided a communication method of a terminal of a system that performs periodic information collection in a wireless multihop network,

the communication method including:

based on a hop count from a sink node constituting the wireless multihop network and the number of terminals per hop, calculating a transmittable period of a routing control message per hop so as to establish a path toward the sink node and a transmittable period of an information collection message per hop so as to transmit collected information toward the sink node;

calculating a collision period during which the routing control message collides with the information collection message, based on both of the calculated transmittable periods;

recalculating the transmittable period of the routing control message so as to transmit the routing control message while avoiding the calculated collision period;

creating and transmitting the routing control message within the transmittable period of the routing control message according to a hop count of the terminal itself; and

creating and transmitting the information collection message within the transmittable period of the information collection message according to a hop count of the terminal itself.

### Advantages Effects of the Invention

According to the present invention, in a wireless multihop network, transmission timings of a routing control message and an information collection message are determined, based on a hop count from a sink node and the number of terminals per hop. Therefore, the information collection and the routing control can be performed at the same time, and the information collection can be performed within a required time by preventing a delay of information collection caused by the collision between the routing control message and the information collection message.

### BRIEF DESCRIPTION OF DRAWINGS

FIG. 1 A figure illustrates a configuration example of an information collection system using a wireless multihop network according to an embodiment of the present invention.

FIG. 2 A figure illustrates a transmission example of a routing control message in the information collection system illustrated in FIG. 1.

FIG. 3 A figure illustrates a transmission example of an information collection message in the information collection system illustrated in FIG. 1.

FIG. 4 A figure describes a schedule table showing a relationship between each transmittable period of the routing control message and the information collection message and a hop count in the information collection system illustrated in FIG. 1.

FIG. 5 A figure describes a case where the collision with the information collection message occurs in a schedule of a transmission timing of the routing control message in the information collection system illustrated in FIG. 1.

FIG. 6 A figure describes a case where an interference avoidance period is set for avoiding the collision between the routing control message and the information collection message illustrated in FIG. 5.

FIG. 7 A figure describes a case where the transmittable period of the routing control message is recalculated after the interference avoidance period illustrated in FIG. 6 is set.

FIG. 8 A figure illustrates a functional configuration of a sink node and a terminal illustrated in FIG. 1.

FIG. 9 A figure illustrates a schematic flow chart describing a process of calculating the transmittable periods of the information collection message and the routing control message by the terminal illustrated in FIG. 8.

FIG. 10 A figure illustrates a schematic flow chart describing the transmission control of the information collection message by the terminal illustrated in FIG. 8.

FIG. 11 A figure illustrates a schematic flow chart describing the transmission control of the routing control message by the terminal illustrated in FIG. 8.

### DESCRIPTION OF EMBODIMENTS

Hereinafter, embodiments of an information collection system, a terminal, and a sink node using a wireless multihop network, and a communication method for the same according to the present invention will be described in detail with reference to the drawings.

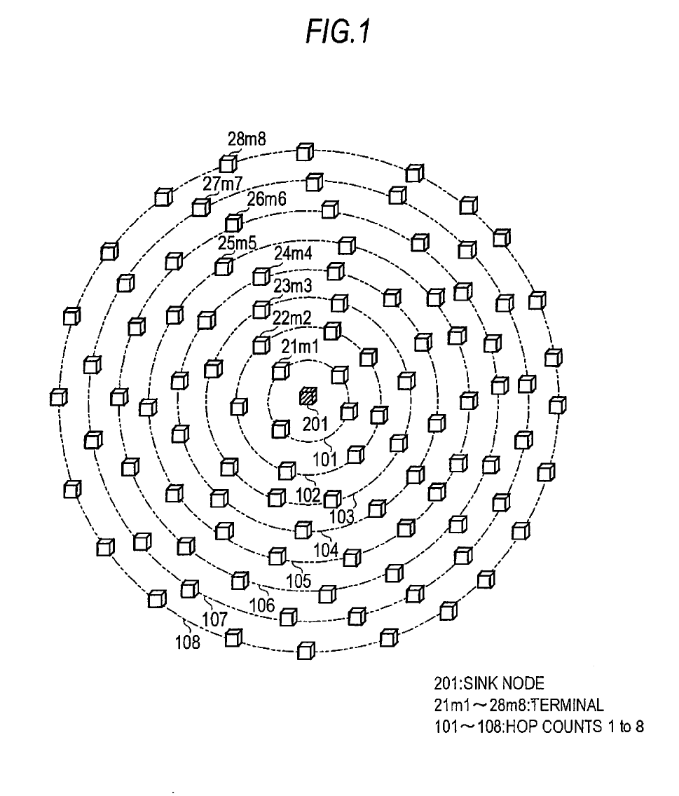

FIG. 1 illustrates a configuration overview of an information collection system using a wireless multihop network according to the present embodiment.

A sink node 201 existing at the center of concentric circles 101 to 108 illustrated in FIG. 1 is a server (information collection server) that collects information from each of terminals 21n to 28n indicated by other “□” in the drawing.

The concentric circles 101 to 108 represent hop counts 1 to 8 from the sink node 201 in the wireless communication, and terminals 21m1 to 28m8 arranged on the concentric circles 101 to 108 represent a group of terminals that are reachable at the hop counts indicated by the concentric circles 101 to 108 from the sink node 201.

For example, the terminal 21m1 existing on the concentric circle 101 is a terminal that can communicate at the hop count 1 from the sink node 201, that is, can directly communicate with the sink node 201. The terminal 22m2 existing on the concentric circle 102 is a terminal that can communicate with the sink node 201 at the hop count 2 through one or more terminals 21m1 existing on the concentric circle 101. In a similar manner, the terminal 21mn existing on the concentric circle 10n can communicate with the sink node 201 through one or more terminals 21m(n−1) existing on the concentric circle 10(n−1).

In FIG. 1, the wireless multihop network of the maximum hop count 8 is illustrated. Also, in the example of the same drawing, each of the terminals 21m1 to 28m8 is concentrically arranged for simplicity of description, but may be arbitrarily arranged in practice.

(1) Routing Control Toward Sink Node

Each of the terminals 21m1 to 28m8 is required to determine a relay terminal that performs communication to the sink node 201. For the routing control, the sink node 201 and each of the terminals 21m1 to 28m8 periodically transmit a routing control message.

The routing control message contains the following information.
Node ID (hereinafter, simply referred to as “ID” when needed)
Hop count
List of adjacent terminals
Number of terminals at each hop
   The node ID represents an ID of the node itself, the hop count represents a hop count of the node itself, the list of adjacent terminals represents a list of IDs of adjacent terminals (or sink nodes), and the number of terminals at each hop represents number of terminals per hop.

Among them, the number of terminals at each hop is set by the sink node 201 from information about the hop count of each terminal, which is set in the information collection message in the last periodic information collection to be described below. Terminals other than the sink node 201 copy the received information about the number of terminals at each hop.

First, regarding only the first routing control message after the network starts up, each terminal receives a routing control message at the first time and waits for a random time, and then, creates and transmits its own routing control message.

Regarding the routing control messages at the second and subsequent time, the transmittable periods of the routing control messages are calculated from their own hop counts, and the routing control messages are created and transmitted at random timings within the periods.

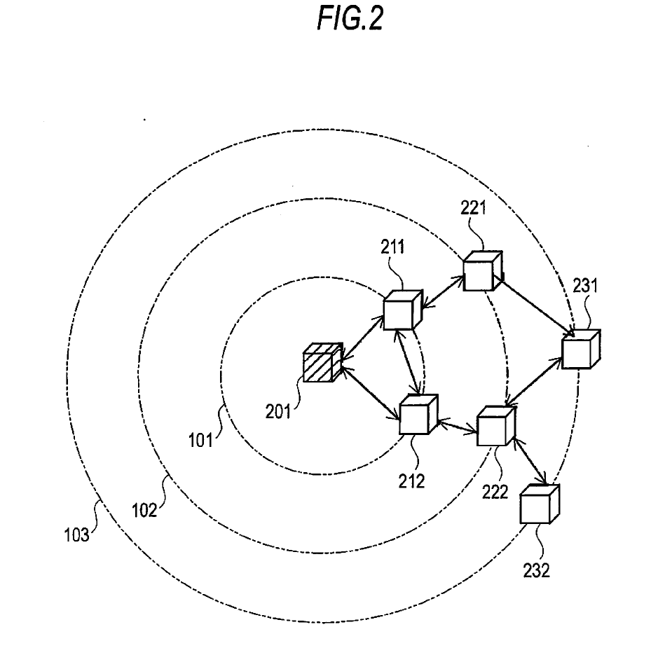

Hereinafter, a routing control method by exchange of the routing control messages at the second and subsequent time will be described with reference to FIG. 2.

FIG. 2 exemplifies the sink node 201, two terminals 211 and 212 of the hop count 1 existing on the concentric circle 101, two terminals 221 and 222 of the hop count 2 existing on the concentric circle 102, and two terminals 231 and 232 of the hop count 3 existing on the concentric circle 103 (in this example, the terminals of the hop count 4 or more are omitted for convenience).

In FIG. 2, first, the sink node 201 transmits the routing control message by broadcast. The content of the routing control message transmitted by the sink node 201 is as follows.

(a1) Routing Control Message of Sink Node 201
ID: 201
Hop count: 0
List of adjacent terminals: 211, 212
Number of terminals at each hop: 1(2), 2(2), 3(2), . . .
   In this example, ID is set to 201, which is an ID of the sink node, and the hop count is set to 0.

Also, the list of adjacent terminals is set to 211 and 212. This is because in the exchange of the routing control messages until the last time, the sink node 201 can receive the routing control messages of the terminals 211 and 212.

Furthermore, in the number of terminals at each hop, two terminals of the hop count 1, two terminals of the hop count 2, and two terminals of the hop count 3 are set (in this example, the hop count 4 or more is omitted for convenience).

The terminals 211 and 212 receive the routing control message transmitted by the sink node 201. The terminals 211 and 212 create and transmit the routing control messages within a previously calculated transmittable period of the hop count 1, which is to be described below. The routing control messages transmitted by the terminals 211 and 212 are as follows.

(a2) Routing Control Message of Terminal 211
ID: 211
Hop count: 1
List of adjacent terminals: 201, 212, 221
Number of terminals at each hop: 1(2), 2(2), 3(2), . . .

(a3) Routing Control Message of Terminal 212
ID: 212
Hop count: 1
List of adjacent terminals: 201, 211, 222
Number of terminals at each hop: 1(2), 2(2), 3(2), . . .
   In this example, IDs are set to their own IDs 211 and 212, respectively.

Also, the hop counts are set to 1, respectively. The hop count is equal to the sum of 1 and the minimum one in hop count information contained in the routing control message, which is received by itself and in which its own ID exists in the list of adjacent terminals. In this case, since the hop counts 0 contained in the routing control messages received from the sink node 201 by the terminals 211 and 212 are all the minimum hop count, the hop counts of the terminals 211 and 212 are all equal to the sum of 0 and 1, that is, 1.

Also, the list of adjacent terminals is set to 201, 212 and 221 in the terminal 211, and is set to 201, 211 and 222 in the terminal 212. This is because in the exchange of the routing control messages until the last time, the terminal 211 can receive the control routing messages of the sink node 201 and the terminals 212 and 221, and the terminal 212 can receive the control routing messages of the sink node 201 and the terminals 211 and 222.

As described above, the number of terminals at each hop is a copy of that contained in the routing control message of the sink node 201.

In a similar manner, the routing control messages transmitted by the terminals 221 to 232 are as follows.

(a4) Routing Control Message of Terminal 221
ID: 221
Hop count: 2
List of adjacent terminals: 211
Number of terminals at each hop: 1(2), 2(2), 3(2), . . .

(a5) Routing Control Message of Terminal 222
ID: 222
Hop count: 2
List of adjacent terminals: 212, 231, 232
Number of terminals at each hop: 1(2), 2(2), 3(2), . . .

(a6) Routing Control Message of Terminal 231
ID: 231
Hop count: 3
List of adjacent terminals: 221, 222
Number of terminals at each hop: 1(2), 2(2), 3(2), . . .

(a7) Routing Control Message of Terminal 232
ID: 232
Hop count: 3
List of adjacent terminals: 222
Number of terminals at each hop: 1(2), 2(2), 3(2), . . .
   Herein it is assumed that, between the terminals 221 and 231, for some reason, the terminal 231 can receive the routing control message of the terminal 221, but the terminal 221 cannot receive the routing control message of the terminal 231. Therefore, the routing control message of the terminal 221 does not contain 231 in the list of adjacent terminal list.

After the exchange of the routing control messages as described above, each terminal determines a relay terminal that is available when its own terminal transmits data to the sink node 201. The relay terminal is a set of adjacent terminals that satisfy the following two conditions.

(Condition 1) The hop count is smaller than the terminal's own hop count.

(Condition 2) The terminal's own ID is contained in the other party's list of adjacent terminals.

Therefore, each terminal's list of relay terminals is as follows.

Terminal 211: 201

Terminal 212: 201

Terminal 221: 211

Terminal 222: 212

Terminal 231: 222

Terminal 232: 222

When there is a plurality of terminals that can be the relay terminals, the best terminal may be selected, considering reception quality or the like of the routing control message. Also, the other relay terminals may be used as alternative relay terminals when the best relay terminal is unavailable.

Each terminal transmits an information collection message, which is to be described below, to the relay terminal.

(2) Transmission of Information Collection Message

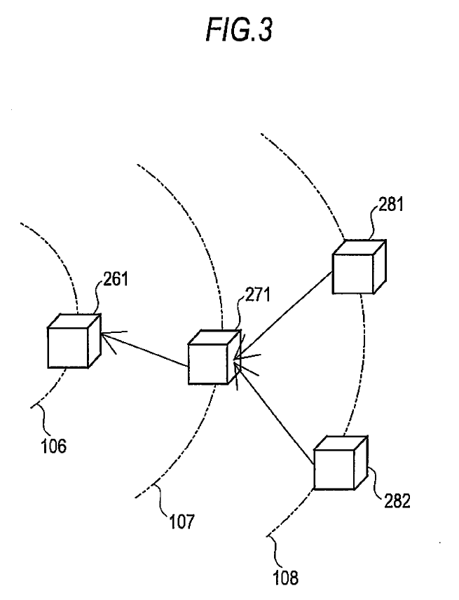

Next, a method for transmitting the information collection message will be described with reference to FIG. 3.

FIG. 3 exemplifies one terminal 261 of the hop count 6 existing on the concentric circle 106, one terminal 271 of the hop count 7 existing on the concentric circle 107, and two terminals 281 and 282 of the hop count 8 (maximum hop count) existing on the concentric circle 108 (in this example, the terminals of the hop count 5 or less and the sink node are omitted for convenience).

In a transmittable period of an information collection message at each hop count, which is calculated by a method to be described below, each terminal rounds up information reported by the terminal itself and information transmitted to the terminal itself from the terminal of one hop count ahead, and creates and transmits an information collection message.

The information collection message contains the following information.
Information ID of the terminal itself:hop count:report information+information contained in information collection message received by the terminal itself) In FIG. 3, first, in the transmission period of the terminal of the hop count 8, the terminals 281 and 282 transmit the information collection messages. The transmission destination of the message is the terminal 271 that is the relay terminal determined in the above-described routing control message.

The following shows the information collection messages transmitted by the terminals 281 and 282. Herein, aaaaaa and bbbbbb contain arbitrary information according to a system or application.

(b1) Information Collection Message Transmitted by Terminal 281
Information (281:8:aaaaaa)

(b2) Information Collection Message Transmitted by Terminal 282
Information (282:8:bbbbbb)
   After the terminal 271 receives the information collection messages from the terminals 281 and 282, when the transmission period of the hop count 7 comes, the terminal 271 creates and transmits the following information collection message to the terminal 261.

(b3) Information Collection Message Transmitted by Terminal 271
Information (271:7:cccccc, 281:8:aaaaaa, 282:8:bbbbbb)
   In a similar manner, each terminal performs the transmission of the information collection message within the transmittable period according to the hop count. Finally, the sink node 201 receives report information and hop counts of all terminals.

(3) Routing Control in Direction from Sink Node to Terminal

In the information collection process of the above (2), the routing control in a direction from the sink node 201 to each terminal is also performed at the same time. The terminal having received the information collection message records the terminal having transmitted the information collection message as the relay terminal, with respect to the terminal included in the information of the message.

In the example of FIG. 3, when receiving data addressed to the terminals 271, 281 and 282, the terminal 261 transmits the data to the terminal 271.

The following shows an example of a data transmission table of the terminal 261.

Destination 271: Forwarding destination 271

Destination 281: Forwarding destination 271

Destination 282: Forwarding destination 271

By using the data transmission table, communication can be performed between the sink node 201 and an arbitrary terminal and between two arbitrary terminals. In a case where data addressed to a certain terminal is received, if there is consistent with the destination of the transmission table, transmission to the forwarding destination is performed. If not, transmission to the relay terminal in the direction of the sink node is performed.

(4) Calculation of Transmittable Period

The sink node 201 can know the number of terminals at each hop from the information collection message. For example, the sink node 201 can know how many hops ahead the terminals are away from the sink node 201 and how many terminals exist at each hop. Since the sink node 201 transmits information about the number of terminals at each hop after inserting the information into the routing control message, all terminals can know the number of terminals at each hop.

Each terminal calculates the transmittable periods of the routing control message and the information collection message at each hop from the information about the number of terminals at each hop.

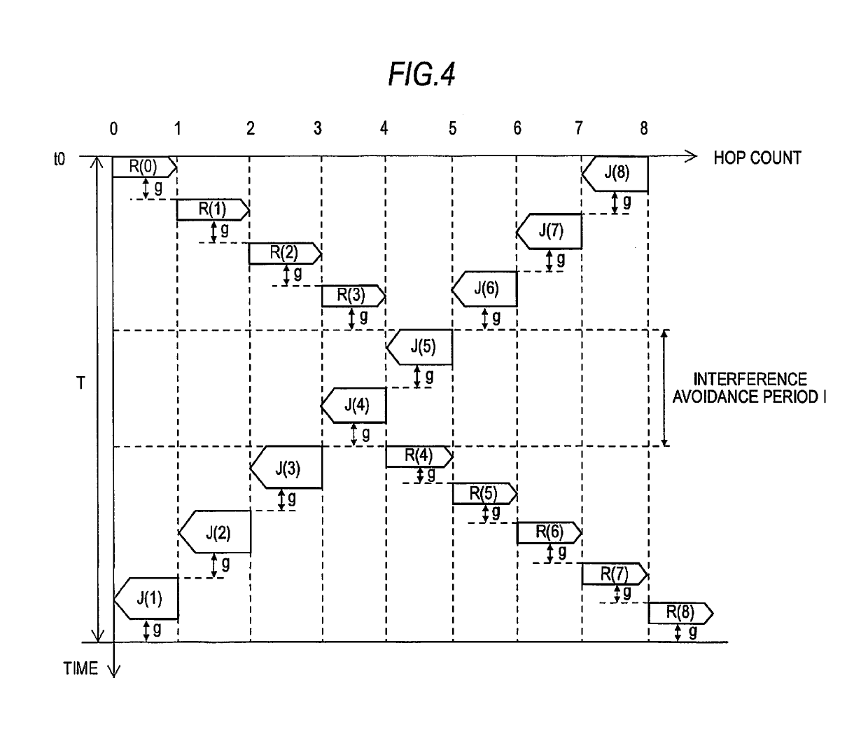

FIG. 4 roughly illustrates each transmission schedule of the information collection message and the routing control message.

In FIG. 4, an information collection period is denoted by T, and a start time thereof is denoted by t0. Herein, the information collection period T and the start time t0 thereof (for example, 0 minute and 30 minutes every hour) are assumed to be previously set to the sink node 201 and each terminal.

Also, the hop counts from the sink node 201 are denoted by h, and the maximum hop count from the sink node 201 among the hop counts h is denoted by Hmax (h=0, 1, 2, . . . , Hmax). In the following description, the maximum hop count Hmax is assumed as 8 (in the example of FIG. 4, h=0, 1, 2, . . . , 8).

The number of terminals in the hop count h is denoted by N(h). Also, since the hop count 0 is only the sink node 201, N(0)=1.

A guard time for avoiding transmission collision between hops due to a time lag between terminals is denoted by g.

In the information collection period T, J(h) (in the example of FIG. 4, J(1) to J(8)) is a period during which the terminal of the hop count h is allowed to transmit the information collection message to the relay terminal of the hop count h−1, which is one hop count ahead, that is, the transmittable period of the information collection message at each hop.

In the information collection period T, R(h) (in the example of FIG. 4, R(0) to R(7)) is a period during which the terminal of the hop count h is allowed to transmit the routing control message, that is, the transmittable period of the routing control message at each hop.

In the information collection period T, an interference avoidance period I is a period during which the transmission of the routing control message is stopped so as to prevent interference between the transmission of the information collection message and the transmission of the routing control message.

In the information collection period T illustrated in FIG. 4, the information collection message reaches the sink node 201 by transmission in each transmittable period J(8), J(7), J(6), . . . , J(1) in order of terminals whose hop counts gradually decrease, that is, in order of terminals of hop counts 8, 7, 6, . . . , 1. Meanwhile, on the contrary to this, the routing control message is transmitted from the sink node 201 and transmitted in each transmittable period R(1), R(2), (R3), . . . , R(8) in a direction of terminals whose hop counts gradually increase, that is, in a direction of terminals of hop counts 1, 2, 3, . . . , 8.

Hereinafter, a method for calculating the transmittable period J(h) of the information collection message, the transmittable period R(h) of the routing control message, and the interference avoidance period I will be described.

(4-1) Calculation of Transmittable Period J(h) of Information Collection Message

First, the transmission schedule of the information collection message, that is, the transmittable period J(h) of the information collection message at each hop, is calculated.

The length of the transmittable period J(h) of the information collection message at each hop is determined, considering the number of terminals at each hop, the amount of information to be transmitted, and the degree of interference. For example, as the number N(h) of terminals existing in the hop count h is larger, the period J(h) is set to be longer. Also, as the hop count h is smaller, the amount of information transmitted by a single terminal increases. Hence, the period J(h) is lengthened. Furthermore, as the hop count h is smaller, the degree of interference increases. Hence, the period J(h) is set to be long.

Assuming that time necessary to transmit information per terminal is set as m, overhead time necessary for a single terminal to transmit a message (collision avoidance protocol control time such as header transmission time+CSMA/CA (Carrier Sense Multiple Access with Collision Avoidance)) is set as p, and the average bandwidth usage is set as s, a minimum transmission time Jmin(h) necessary at the hop count h is calculated as follows.

Jmin(h)=[{N(h)+N(h+1)+ . . . +N(Hmax)}*m+N(h)*p]*(1/s) (Mathematical formula 1)

However, as the hop count h increases, the probability that a plurality of terminals can transmit messages at the same time increases. Therefore, for example, Jmin(h) is corrected according to the hop count h as follows.

Jmin′(h)=Jmin(h)*ĥ(−½) (Mathematical formula 2)

Herein, in the information collection period T, transmission time Jext capable of being allocated extra in total can be calculated as follows.

Jext=T−g*Hmax−{Jmin′(1)+Jmin′(2)+ . . . +J′(Hmax)} (Mathematical formula 3)

The Jext is allocated according to a weight w(h) of each hop. The weight w(h) is calculated as follows.

w′(h)=N(h)*(1/h)*{N(h)+N(h+1)+ . . . +N(Hmax)}

w(h)=w′(h)/{w′(1)+w′(2)+ . . . +w′(Hmax)} (Mathematical formula 5)

Therefore, J(h) is calculated as follows.

J(h)=Jmin′(h)+w(h)*Jext (Mathematical formula 6)

Herein, in the information collection period T, when the information collection start time is set as t0, the start time Tj(h)_start of the transmittable period J(h) of the information collection message at each hop count h (h=1, . . . , Hmax−1, Hmax) and the end time Tj(h)_end of the transmittable period J(h) thereof are as follows.

$$Tj ( H max ) \_start = t 0 \\ Tj ( H max ) \_end = t 0 + J ( H max ) \\ Tj ( H max \text{-} 1 ) \_start = Tj ( H max ) \_end + g \\ Tj ( H max \text{-} 1 ) \_end = Tj ( H max \text{-} 1 ) \_start + J ( H max \text{-} 1 ) \\ Tj ( H max \text{-} 2 ) \_start = Tj ( H max \text{-} 1 ) \_end + g \\ Tj ( H max \text{-} 2 ) \_end = Tj ( H max \text{-} 2 ) \_start + J ( H max \text{-} 2 ) \\ … \\ Tj ( 1 ) \_start = Tj ( 2 ) \_end + g \\ Tj ( 1 ) \_end = Tj ( 1 ) \_start + J ( 1 ) \qquad ( Math . 6 )$$

(4-2) Calculation of Transmittable Period R(h) of Routing Control Message and Interference Avoidance Period I

Next, the calculation of the transmission schedule of the routing control message, that is, the transmittable period R(h) of the routing control message at each hop, and the interference avoidance period I is performed.

Unlike the information collection message, any terminal transmits a routing control message of a constant size.

Also, R(0) is finished in a very short time because the sink node 201 just broadcasts a single routing control message.

When the time necessary to transmit the single routing control message is set as q, the minimum transmission period Rmin(h) of the routing control message necessary at each hop is as follows.

Rmin(h)=N(h)*(p+q)*(1/s) (Mathematical formula 7)

As the hop count h increases, the probability that a plurality of terminals can transmit messages at the same time increases. Therefore, for example, Rmin(h) is corrected according to the hop count h as follows. Herein, the corrected Rmin(h) is denoted by Rmin′(h).

Rmin′(h)=Rmin(h)*ĥ(−½) (Mathematical formula 8)

In the information collection period T, the transmittable period of the routing control message from the start time t0 is set based on Rmin′(h). That is, when the start time of the information collection period T is set as t0, the following is obtained. Herein, Tr(h)_start represents the start time of the transmittable period R(h) of the routing control message at each hop count h (h=0, 1, . . . , Hmax), and Tr(h)_end represents the end time of the transmittable period R(h) thereof.

$$Tr ( 0 ) \_start = t 0 \\ Tr ( 0 ) \_end = t 0 + R {min}^{′} ( 0 ) \\ Tr ( 1 ) \_start = Tr ( 0 ) \_end + g \\ Tr ( 1 ) \_end = Tr ( 1 ) \_start + R {min}^{′} ( 1 ) \\ … \\ Tr ( H max ) \_start = Tr ( H max \text{-} 1 ) \_end + g \\ Tr ( H max ) \_end = Tr ( H max ) \_start + R {min}^{′} ( H max ) \qquad ( Mathematical formula 9 )$$

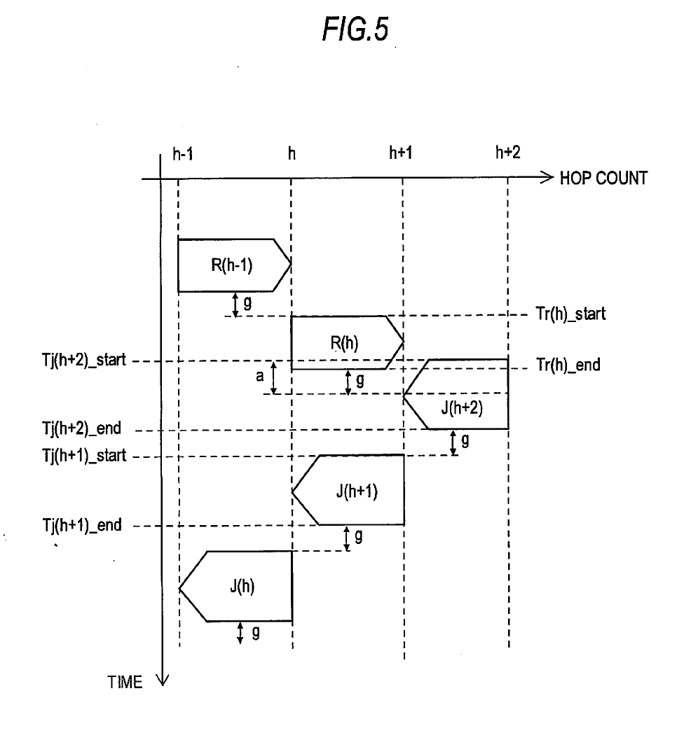

As illustrated in FIG. 5, when a period from the start time Tr(h)_start of the transmittable period R(h) of the routing control message at the hop count h to the end time Tr(h)_end+guard time g is overlapped with a period from the start time Tj(h+2)start of the transmittable period J(h+2) of the information collection message at the hop count h+2 to the end time Tj(h+2)_end (see the overlap period a of FIG. 5), the transmission of the information collection message and the transmission of the routing control message collides with each other at the hop count h+1.

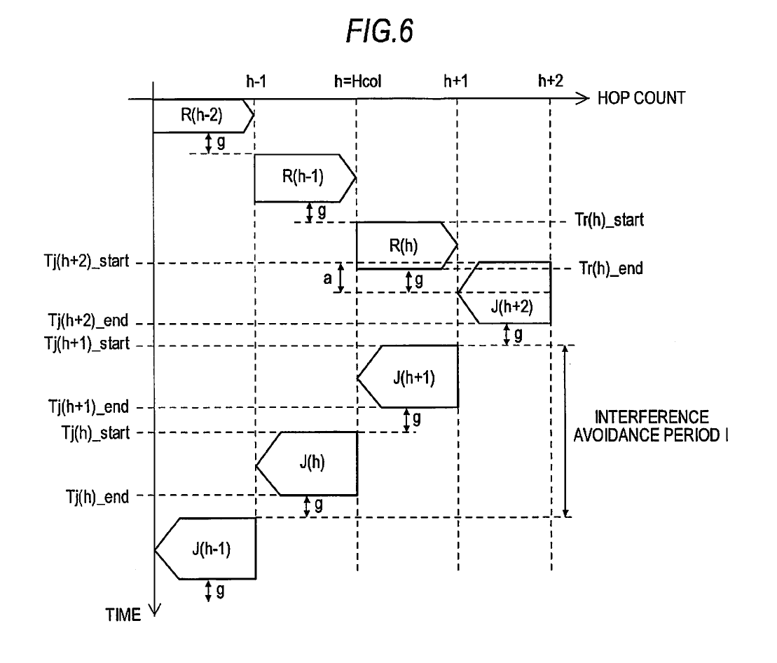

In order to avoid the collision, as illustrated in FIG. 6, the period from the start time Tj(h+1)start of the transmittable period J(h+1) of the information collection message at the hop count h+1 to the end time Tj(h)_end of the transmittable period J(h) of the information collection message at the hop count h+ the guard time g is set as the interference avoidance period I during which the transmission of the routing control message is stopped. Hereinafter, the hop count h at the hop that transmits the colliding routing control message is denoted by Hcol.

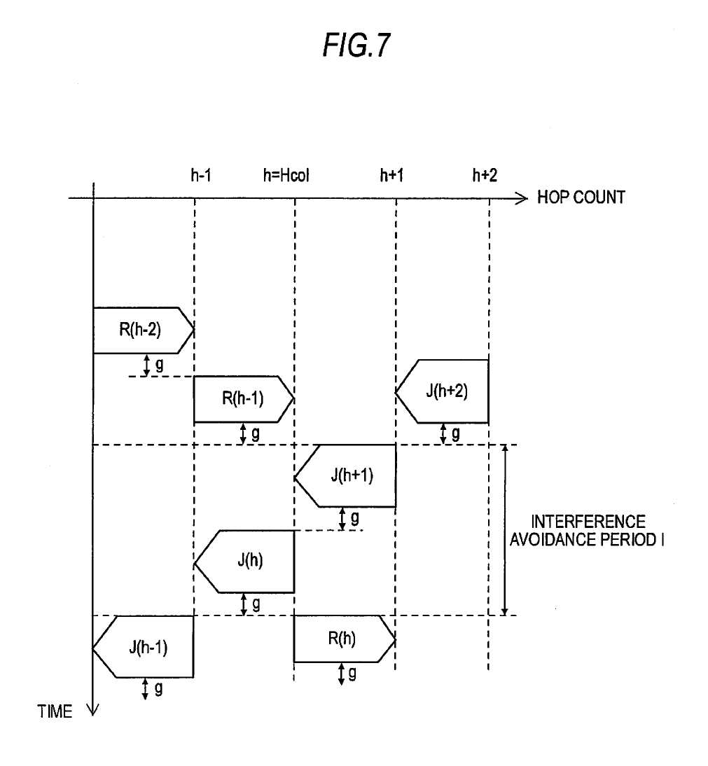

After determining the interference avoidance period I as described above, the transmittable period R(h) of the routing control message at each hop is recalculated such that the transmission of the routing control message is not overlapped with the interference avoidance period I as illustrated in FIG. 7.

First, a period from the transmittable period R(0) of the routing control message at the hop count 0 to the transmittable period R(Hcol−1) of the routing control message at the hop count Hcol−1 is allocated between the transmittable period J(Hmax) of the information collection message at the hop count Hmax and the transmittable period J(Hcol+2) of the information collection message at the hop count Hcol+2.

Herein, when Tr1=J(Hmax)+ . . . +J(Hcol+2), the transmission time Rext1 that can be allocated extra at Tr1 can be calculated as follows.

Rext1=Tr1−g*Hcol−{Rmin′(0)+Rmin′(1)+ . . . +Rmin′(Hcol-1)} (Mathematical formula 10)

The Rext1 is allocated according to a weight y(h) of each hop. The weight y(h) of each hop is calculated as follows.

y′(h)=ĥ(½)

y(h)=y′(h)/{y′(0)+y′(1)+ . . . +y′(Hcol−1)} (Mathematical formula 11)

Finally, the transmittable period R(h) (R(0) to R(Hcol−1)) of the routing control message at the hop count h(0 to Hcol−1) is calculated as follows.

R(h)=Rmin′(h)+y(h)*Rext1 (Mathematical formula 12)

Then, a period from the transmittable period R(Hcol) of the routing control message at the hop count Hcol to the transmittable period R(Hmax) of the routing control message at the hop count Hmax is allocated between the transmittable period J(Hcol−1) of the information collection message at the hop count Hcol−1 and the transmittable period J(1) of the information collection message at the hop count 1.

Herein, when Tr2=J(Hcol+1)+ . . . +J(1), the transmission time Rext2 that can be allocated extra at Tr2 can be calculated as follows.

Rext2=Tr2−g*(Hmax−Hcol+1)−{Rmin′(Hcol)+Rmin′(Hcol+1)+ . . . +Rmin′(Hmax)} (Mathematical formula 13)

The Rext2 is allocated according to a weight y(h) of each hop. The weight y(h) of each hop is calculated as follows.

y′(h)=ĥ(½)

y(h)=y′(h)/{y′(Hcol)+y′(Hcol+1)+ . . . +y′(Hmax)} (Mathematical formula 14)

Finally, the transmittable period R(h) (R(Hcol) to R(Hmax)) of the routing control message at the hop count h (Hcol to Hmax) is calculated as follows.

R(h)=Rmin′(h)+y(h)*Rext2 (Mathematical formula 15)

Based on the calculated transmittable periods J(h) and R(h) of the information collection message and the routing control message at each hop, each terminal transmits the information collection message and the routing control message within the transmittable periods J(h) and R(h) according to its own hop count h.

Therefore, the information collection and the routing control can be performed at the same time, and the information collection can be performed within a required time by preventing a delay of the information collection caused by the collision between the routing control message and the information collection message.

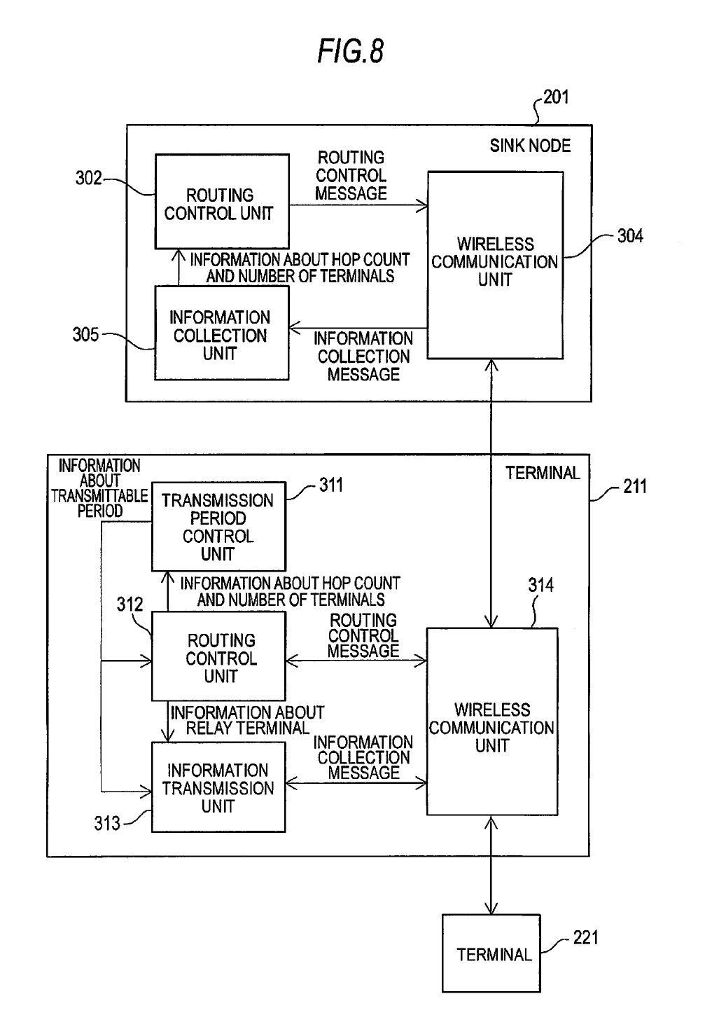

FIG. 8 illustrates a functional configuration of the sink node and the terminal

The wireless multihop network illustrated in FIG. 8 includes the sink node 201, the terminal 211 adjacent to the sink node 201, and the terminal 221 adjacent to the terminal 211 (the other terminals are omitted for convenience). Also, since the functional configuration of the terminals other than the terminal 211 in the wireless multihop network is identical to that of the terminal 211, only the terminal 211 will be described.

(Functional Configuration of Sink Node)

The sink node 201 includes a routing control unit 302, an information collection unit 305, and a wireless communication unit 304 (besides, a known clock function (not illustrated) and the like are also built in).

The wireless communication unit 304 performs the transmission/reception of the above-described information collection message and routing control message by wireless communication with the adjacent terminal 211.

The information collection unit 305 receives the information collection message through the wireless communication unit 304 and retains the received information collection message.

The routing control unit 302 acquires the information about the number N(h) of terminals of each hop from the information collection message of the information collection unit 305, periodically creates the routing control message, based on the information, and transmits the routing control message to the adjacent terminal 211 through the wireless communication unit 304. In this case, the routing control message is created and transmitted in each information collection period T. In this case, the start time t0 of the information collection period T is determined by, for example, time of the built-in clock function.

(Functional Configuration of Terminal)

The terminal 211 includes a transmission period control unit 311, a routing control unit 312, an information transmission unit 313, and a wireless communication unit 314 (besides, a known clock function (not illustrated) and the like are also built in).

The wireless communication unit 314 performs the transmission/reception of the above-described information collection message and routing control message by wireless communication between the sink node 201 and another adjacent terminal 221.

As described above, the transmission period control unit 311 acquires the information about the hop count h of the self terminal and the number N(h) of terminals at each hop from the routing control unit 312, calculates the transmittable periods J(h) and R(h) of the information collection message and the routing control message at each hop, and notifies the transmittable periods J(h) and R(h) to the routing control unit 312 and the information transmission unit 313.

In the information collection period T, based on the transmittable period R(h) of the routing control message according to hop count h of the terminal itself, which is notified from the transmission period control unit 311, the routing control unit 312 creates the above-described routing control message between the start time Tr(h)_start and the end time Tr(h)_end, and transmits the created routing control message to the adjacent terminal 221 through the wireless communication unit 304. By the exchange of the routing control message, as described above, a relay terminal available when transmitting the information collection message to the sink node 201 is determined, and communication paths are established between the sink node and the terminal and between two terminals. Also, the start time Tr(h)_start and the end time Tr(h)_end of the transmittable period R(h) of the routing control message are determined by, for example, time of the built-in clock function.

In the information collection period T, based on the transmittable period J(h) of the information collection message according to the hop count h of the self terminal, which is notified from the transmission period control unit 311, the information transmission unit 313 creates the above-described information collection message between the start time Tj(h)_start and the end time Tj(h)_end, and transmits the created information collection message to the relay terminal acquired from the routing control unit 312. Also, the information transmission unit 313 acquires the information collection message from the adjacent terminal 221 through the wireless communication unit 314, and inserts the information included therein into an information collection message to be created next time. Also, the start time Tj(h)_start and the end time Tj(h)_end of the transmittable period J(h) of the information collection message are determined by, for example, time of the built-in clock function.

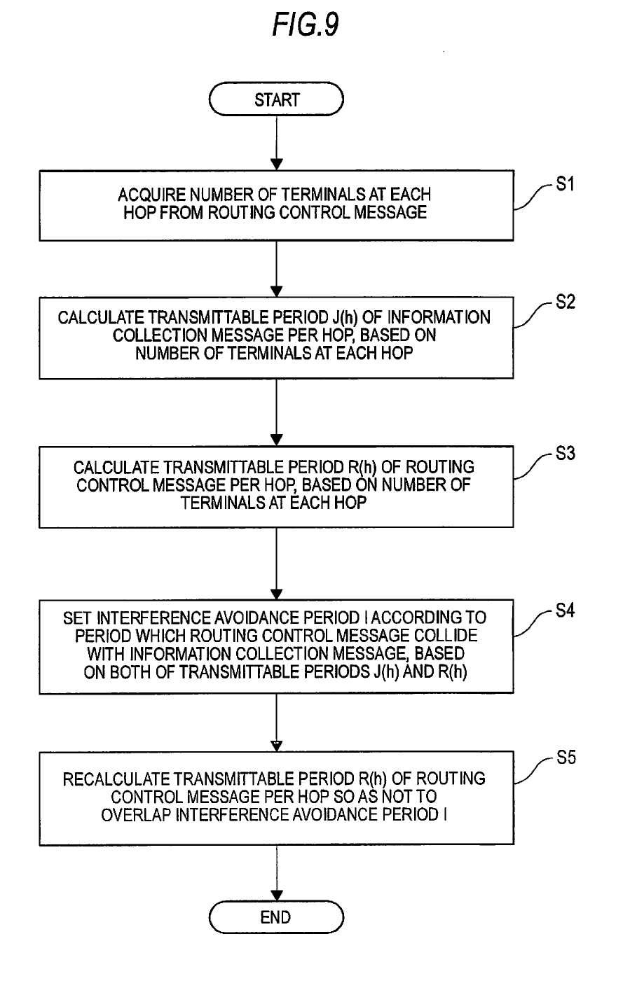

FIG. 9 describes a processing flow of calculating the transmittable periods of the information collection message and the routing control message by the transmission period control unit 311 of the terminal 211.

As illustrated in FIG. 9, the transmission period control unit 311 of the terminal 211 acquires the number of terminals at each hop from the routing control message from the sink node 201 (step S1), and calculates the transmittable period J(h) of the information collection message at each hop and the transmittable period R(h) of the routing control message at each hop, based on the acquired number of terminals at each hop (steps S2 and S3). The transmission period control unit 311 of the terminal 211 sets the interference avoidance period I according to the period during which the routing control message collides with the information collection message, based on J(h) and R(h) (step S4), and recalculates the transmittable period R(h) of the routing control message such that the transmittable period R(h) is not overlapped with the interference avoidance period I (step S5).

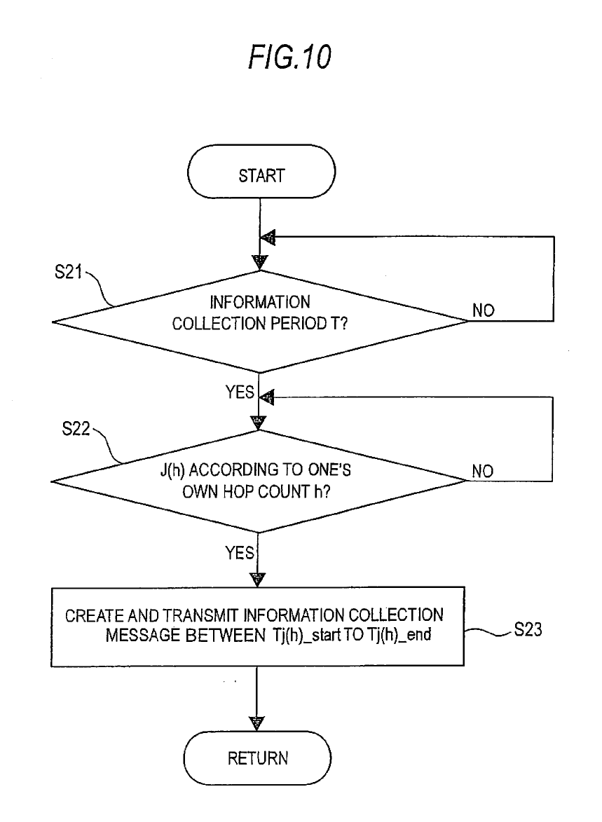

FIG. 10 describes a flow of controlling the transmission of the information collection message by the terminal 211.

As illustrated in FIG. 10, the terminal 211 determines whether T has arrived by the start time t0 of the previously set information collection period T (step S21). When T has arrived (YES in step S11), the terminal 211 determines whether J(h) has arrived by the start time Tj(h)_start of the transmittable period J(h) of the information collection message according to hop count h of the terminal itself (step S22). When J(h) has arrived (YES in step S22), the information transmission unit 313 of the terminal 211 creates and transmits its own information collection message between the start time Tj(h)_start and the end time Tj(h)_end (step S23).

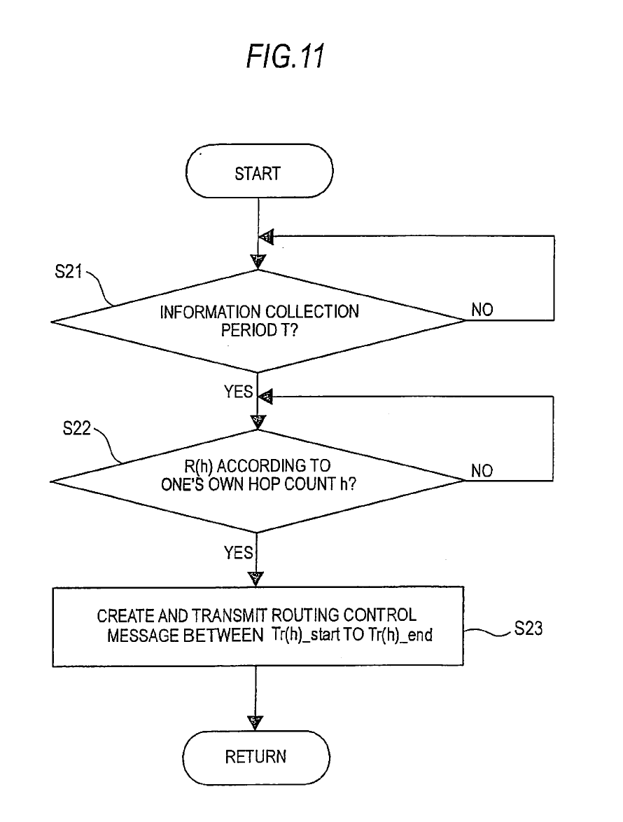

FIG. 11 describes a flow of controlling the transmission of the routing control message by the terminal 211.

As illustrated in FIG. 11, the terminal 211 determines whether the information collection period T has arrived by the start time t0 of the previously set information collection (step S21). When T has arrived (YES in step S21), the terminal 211 determines whether R(h) has arrived by the start time Tr(h)_start of the transmittable period R(h) of the routing control message according to its own hop count h (step S22). When R(h) has arrived (YES in step S22), the routing control unit 312 of the terminal 211 creates and transmits its own routing control message between the start time Tr(h)start and the end time Tr(h)_end (step S23).

Also, as other embodiments, in (1) of the embodiment, the number of dummy (fictitious) terminals may be set to the hop count greater than the maximum hop count (8 in the above example) checked by the sink node 201 in the “number of terminals at each hop” of the routing control message created by the sink node 201 (in the example of FIG. 8, the routing control unit 302). For example, information that terminals corresponding to 10% of the number of terminals of the hop count 8 exist at the hop count 9 is inserted as dummy.

Therefore, in addition to the above effects, it is possible to cope with a variation in the maximum hop count due to the routing change or the addition of new terminals.

Also, the calculation of (4) of the embodiment may be performed by the sink node 201 as a representative, instead of the terminal In this case, as the functional configuration of the sink node 201, a configuration that further includes a transmission period control unit having the same function as the transmission period control unit 311 of the terminal 211 illustrated in the example of FIG. 8 is exemplified.

In this configuration, the information about the calculated transmittable periods J(h) and R(h) of the information collection message and the routing control message at each hop, or information about the start time Tj(h)_start and the end time Tj(h)_end of J(h) and the start time Tr(h)_start and the end time Tr(h)_end of R(h), may be transmitted while being inserted into the routing control message created and transmitted by the sink node 201 (in the example of FIG. 8, the routing control unit 302). In this case, each terminal transmits the information collection message and the routing control message, based on the transmission schedule of the received information collection message and routing control message, that is, the transmittable periods of the information collection message and the routing control message at each hop.

Also, the sink node and the terminal constituting the wireless multihop network may be realized by hardware, software, or a combination thereof In this case, the hardware or software configuration is not specially limited, and any type of a configuration can be applied as long as the configuration can realize the above-described functions.

A part or all of the embodiments can be described as the following supplementary notes, but are not limited to the following.

{Supplementary note 1} A terminal of a system that performs periodic information collection in a wireless multihop network,

the terminal comprising:

a transmission period control unit that, based on a hop count from a sink node constituting the wireless multihop network and the number of terminals at each hop, calculates a transmittable period of a routing control message per hop so as to establish a path toward the sink node and a transmittable period of an information collection message per hop so as to transmit collected information toward the sink node, calculate a collision period during which the routing control message collides with the information collection message, based on both of the calculated transmittable periods, and recalculates the transmittable period of the routing control message so as to transmit the routing control message while avoiding the calculated collision period; a routing control unit that creates and transmits the routing control message within the transmittable period of the routing control message according to a hop count of the terminal itself; and

an information transmission unit that creates and transmits the information collection message within the transmittable period of the information collection message according to a hop count of the terminal itself

{Supplementary note 2} The terminal according to Supplementary note 1, wherein the number of terminals per hop is transmitted while being inserted into a routing control message created by the sink node, and

the transmission period control unit acquires the number of terminals per hop from the routing control message.

{Supplementary note 3} The terminal according to Supplementary note 1 or 2, wherein the transmission period control unit calculates transmittable periods of a routing control message and an information collection message per hop, the transmittable periods being weighted according to the number of terminals per hop.

{Supplementary note 4} The terminal according to Supplementary note 1, wherein the information transmission unit transmits the information collection message while inserting the hop count of the terminal itself into the information collection message.

{Supplementary note 5} The terminal according to Supplementary note 2, wherein, the number of terminals per hopis is set to a hop count greater than an actual maximum hop count by the sink node, the hop count being the number of fictitious terminals.

{Supplementary note 6} A sink node of a system that performs periodic information collection in a wireless multihop network,

the sink node comprising:

an information collection unit that receives an information collection message for transmitting collected information, which is to be transmitted from a terminal constituting the wireless multihop network toward the sink node; and

a routing control unit that acquires, from the information collection message, the number of terminals per hop from the sink node, and transmits the acquired number of terminals per hop while inserting the acquired number of terminals per hop into a routing control message for establishing a path toward the sink node.

{Supplementary note 7} A sink node of a system that performs periodic information collection in a wireless multihop network,

the sink node comprising:

an information collection unit that receives an information collection message for transmitting collected information, which is to be transmitted from a terminal constituting the wireless multihop network toward the sink node;

a transmission period control unit that acquires, from the information collection message, the number of terminals per hop from the sink node, calculates a transmittable period of a routing control message per hop so as to establish a path from the terminal toward the sink node and a transmittable period of an information collection message per hop so as to transmit collected information toward the sink node, based on the acquired number of terminals per hop, calculate a collision period during which the routing control message collides with the information collection message, based on both of the calculated transmittable periods, and recalculates the transmittable period of the routing control message so as to transmit the routing control message while avoiding the calculated collision period; and

a routing control unit that transmits the calculated transmittable periods of the information collection message and routing control message per hop while inserting the calculated transmittable periods into a routing control message of the sink node itself.

{Supplementary note 8} The sink node according to Supplementary note 7, wherein the transmission period control unit calculates transmittable periods of a routing control message and an information collection message, which are weighted according to the number of terminals per hop, and

the routing control unit notifies the terminal of the calculated transmittable periods of the routing control message and information collection message per hop while inserting the calculated transmittable periods into the routing control message.

{Supplementary note 9} A system that performs periodic information collection in a wireless multihop network, the system comprising a sink node and a terminal which constitute the wireless multihop network,

the sink node comprising:

an information collection unit that retains an information collection message for transmitting collected information, which is to be transmitted from the terminal toward the sink node; and

a routing control unit that acquires, from the information collection message, the number of terminals per hop from the sink node, and transmits the acquired number of terminals per hop while inserting the acquired number of terminals per hop into a routing control message for establishing a path toward the sink node,

the terminal comprising:

a transmission period control unit that calculates transmittable periods of a routing control message per hop and an information collection message per hop, based on a hop count from the sink node and the number of terminals per hop, calculate a collision period during which the routing control message collides with the information collection message, based on both of the calculated transmittable periods, and recalculates the transmittable period of the routing control message so as to transmit the routing control message while avoiding the calculated collision period;

a routing control unit that creates and transmits the routing control message within the transmittable period of the routing control message according to a hop count of the terminal itself; and

an information transmission unit that creates and transmits the information collection message within the transmittable period of the information collection message according to a hop count of the terminal itself.

{Supplementary note 10} A communication method of a terminal of a system that performs periodic information collection in a wireless multihop network,

the communication method comprising:

based on a hop count from a sink node constituting the wireless multihop network and the number of terminals per hop, calculating a transmittable period of a routing control message per hop so as to establish a path toward the sink node and a transmittable period of an information collection message per hop so as to transmit collected information toward the sink node;

calculating a collision period during which the routing control message collides with the information collection message, based on both of the calculated transmittable periods;

recalculating the transmittable period of the routing control message so as to transmit the routing control message while avoiding the calculated collision period;

creating and transmitting the routing control message within the transmittable period of the routing control message according to a hop count of the terminal itself; and

creating and transmitting the information collection message within the transmittable period of the information collection message according to a hop count of the terminal itself.

{Supplementary note 11}A communication method of a sink node of a system that performs periodic information collection in a wireless multihop network, the communication method including: receiving an information collection message for transmitting collected information, which is to be transmitted from a terminal constituting the wireless multihop network toward the sink node; acquiring, from the information collection message, the number of terminals per hop from the sink node; and transmitting the acquired number of terminals per hop while inserting the acquired number of terminals per hop into a routing control message for establishing a path toward the sink node.

{Supplementary note 12} A communication method of a sink node of a system that performs periodic information collection in a wireless multihop network, wherein the sink node receives an information collection message for transmitting collected information, which is to be transmitted from a terminal constituting the wireless multihop network toward the sink node; acquires, from the information collection message, the number of terminals per hop from the sink node; calculates a transmittable period of a routing control message per hop so as to establish a path from the terminal toward the sink node and a transmittable period of an information collection message per hop so as to transmit collected information toward the sink node, based on the acquired number of terminals per hop; calculate a collision period during which the routing control message collides with the information collection message, based on both of the calculated transmittable periods; recalculates the transmittable period of the routing control message so as to transmit the routing control message while avoiding the calculated collision period; and transmits the calculated transmittable periods of the information collection message and the routing control message per hop while inserting the calculated transmittable periods into a routing control message of the sink node.

Although the present invention has been described with reference to the embodiments, the present invention is not limited to the embodiments. In the configurations and details of the present invention, various modifications understandable by those skilled in the art can be made within the scope of the present invention.

This application is based upon and claims the priority of Japanese Patent Application No. 2010-266935, filed on Nov. 30, 2010, the disclosure of which is hereby incorporated by reference in its entirety.

### INDUSTRIAL APPLICABILITY

As described above, the present invention can be used for an information collection system, a terminal and a sink node using a wireless multihop network, and a communication method for the same. In particular, the present invention can be used for a method for scheduling a transmission timing of a control message for routing control and a message for information collection in a system that performs periodic information collection using a wireless multihop network, for example, an automatic metering by smart meter or an information collection system (sensor network) using sensors.

### REFERENCE SIGNS LIST

201 Sink node
21m1 to 21m8, 211, 212, 221, 222, 231, 232, 261, 271, 281, 282 Terminals
101 to 108 Hop counts 1 to 8
302 Routing control unit (sink node)
304 Information collection unit
305 Wireless communication unit (sink node)
311 Transmission period control unit
312 Routing control unit (terminal)
313 Information transmission unit
314 Wireless communication unit (terminal)

What is claimed is:

1. A terminal of a system that performs periodic information collection in a wireless multihop network,
the terminal comprising:
a transmission period control unit that, based on a hop count from a sink node constituting the wireless multihop network and the number of terminals at each hop, calculates a transmittable period of a routing control message per hop so as to establish a path toward the sink node and a transmittable period of an information collection message per hop so as to transmit collected information toward the sink node, calculate a collision period during which the routing control message collides with the information collection message, based on both of the calculated transmittable periods, and recalculates the transmittable period of the routing control message so as to transmit the routing control message while avoiding the calculated collision period;
a routing control unit that creates and transmits the routing control message within the transmittable period of the routing control message according to a hop count of the terminal itself; and
an information transmission unit that creates and transmits the information collection message within the transmittable period of the information collection message according to a hop count of the terminal itself.

2. The terminal according to claim 1,
wherein the number of terminals per hop is inserted into a routing control message created by the sink node and the routing control message including the number of terminals per hop is transmitted, and the transmission period control unit acquires the number of terminals per hop from the routing control message.

3. The terminal according to claim 1,
wherein the transmission period control unit calculates transmittable periods of a routing control message and an information collection message per hop, the transmittable periods being weighted according to the number of terminals per hop.

4. The terminal according to claim 1,
wherein the information transmission unit inserts the hop count of the terminal itself into the information collection message and transmits the information collection message including the hop count of the terminal itself.

5. The terminal according to claim 2,
wherein, the number of terminals per hopis is set to a hop count greater than an actual maximum hop count by the sink node, the hop count being the number of fictitious terminals.

6. A sink node of a system that performs periodic information collection in a wireless multihop network,
the sink node comprising:
an information collection unit that receives an information collection message for transmitting collected information, which is to be transmitted from a terminal constituting the wireless multihop network toward the sink node; and
a routing control unit that acquires, from the information collection message, the number of terminals per hop from the sink node, and inserts the acquired number of terminals per hop into a routing control message for establishing a path toward the sink node and transmits the routing control message including the acquired number of terminals per hop.

7. A sink node of a system that performs periodic information collection in a wireless multihop network,
the sink node comprising:
an information collection unit that receives an information collection message for transmitting collected information, which is to be transmitted from a terminal constituting the wireless multihop network toward the sink node;
a transmission period control unit that acquires, from the information collection message, the number of terminals per hop from the sink node, calculates a transmittable period of a routing control message per hop so as to establish a path from the terminal toward the sink node and a transmittable period of an information collection message per hop so as to transmit collected information toward the sink node, based on the acquired number of terminals per hop, calculate a collision period during which the routing control message collides with the information collection message, based on both of the calculated transmittable periods, and recalculates the transmittable period of the routing control message so as to transmit the routing control message while avoiding the calculated collision period; and
a routing control unit that inserts the calculated transmittable periods of the information collection message and routing control message per hop into a routing control message of the sink node itself and transmits the routing control message including the calculated transmittable periods.

8. The sink node according to claim 7,
wherein the transmission period control unit calculates transmittable periods of a routing control message and an information collection message, which are weighted according to the number of terminals per hop, and
the routing control unit inserts the calculated transmittable periods of the routing control message and information collection message per hop into the routing control message and notifies the terminal of the routing control message including the calculated transmittable periods.

9. (canceled)

10. (canceled)
